(19) United States
(12) Patent Application Publication
(10) Pub. No.: US 2005/0141811 A1
(43) Pub. Date: Jun. 30, 2005

(54) Tunable filter and the method for making the same

(76) Inventors: Cheng-Lin Yang, Hsinchu (TW); Ying-Tsung Lu, Hsinchu (TW)

Correspondence Address: BIRCH STEWART KOLASCH & BIRCH, PO BOX 747, FALLS CHURCH, VA, 22040-0747, US

(21) Appl. No.: 10/826,284

(22) Filed: Apr. 19, 2004

(30) Foreign Application Priority Data
Dec. 26, 2003 (TW) 092137215

(51) Int. Cl. G02B 6/34

(52) U.S. Cl. 385/37

(57) ABSTRACT

A tunable filter and its manufacturing method are disclosed. Interference of two laser beams defines the grating pattern required by the filter to make a micro grating with a period as small as several hundred nanometers on a polymer film. As the refractive index of the polymer film changes with the temperature, one can control the temperature to adjust the wavelengths of optical signals that the micro grating can reflect.

### BACKGROUND OF THE INVENTION

1. Field of Invention

The invention relates to a tunable filter and the method for making the same. In particular, the invention relates to a tunable filter with a micro grating pattern defined by laser interference and the method for making the same.

2. Related Art

With the popularity of Internet and multimedia, there is a more urgent need for a wider network bandwidth. Optical communication technology plays an important rile in future information transmission. In particular, dense wavelength division multiplexing (DWDM) is the best means to increase the optical fiber communication bandwidth and transmission capacity. By having optical beams of different wavelengths share a single optical fiber, different data signals can be transmitted using different channels. Such signals are converted by a wavelength division multiplexer into a single beam traveling on an optical fiber. Data from different sources are packed to increase the transmission efficiency using the limited optical fiber bandwidth.

For a complete DWDM system, how to dynamically adjust optical signals of different wavelengths is a very important subject. Current tunable filter elements include audio-optical modulated filters, Fabry-Perot filters, film filters, and waveguide filters. In order to be widely used in the DWDM system, a key problem is how to develop a filter with a high reflective efficiency, narrow bandwidth, low attenuation, and small volume. It is further desirable to have a simpler and cheaper manufacturing process. Since polymers have a high thermo-optical coefficient, low propagation attenuation, and cheaper price, they have become ideal materials for filters. As disclosed in the U.S. Pat. No. 6,303,040, the method form a tunable filter by forming a grating on a polymer waveguide. The polymer waveguide is first coated with a polymer film with a high refractive index. The grating pattern is defined on the photoresist layer on the surface of the polymer film using a mercury lamp as a source along with a corresponding phase mask. The period of the grating is limited by the precision of the phase mask; therefore, their grating period is about 1 micrometer.

### SUMMARY OF THE INVENTION

An objective of the invention is to provide a tunable filter and the method for making the same. Interference of two laser beams defines the grating pattern required by the filter to make a micro grating with a period as small as several hundred nanometers on a polymer film. It is then integrated into the structure and manufacturing process of polymer waveguide devices, achieving a tunable filter with a high reflection efficiency and narrow bandwidth.

The tunable filter is used to dynamically modulate optical signals of different wavelengths. It contains a polymer waveguide and a micro grating. The polymer waveguide has a structure for guiding and propagating light. The micro grating is formed on the surface of the polymer waveguide to reflect light of specific wavelengths to different paths, removing light of specific wavelengths. The grating if formed by defining a stripe photoresist pattern on the surface of the polymer film using the interference of two laser beams. As the polymer material has a high thermo-optical coefficient, its refractive index changes with the temperature: dn/dT=−10⁻⁴ where n is the refractive index. Therefore, one can use this property to adjust the wavelengths being reflected.

The disclosed manufacturing method forms a polymer waveguide on a substrate and a micro grating on the polymer waveguide. The steps include: providing a polymer film; coating a photoresist layer on the surface of the polymer film; forming a periodic exposure structure on the photoresist layer using the interference of two laser beams; removing part of the photoresist layer to form a stripe photoresist pattern; and etching the polymer film to form the micro grating and removing the photoresist pattern. The period of the micro grating thus formed can be as small as 400 nm to 600 nm.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of a laser interference device;

FIG. 1A is a schematic view of a periodic exposure structure;

FIG. 2 is a flowchart of a first embodiment;

FIG. 3 is a schematic view of the structure in the first embodiment;

FIG. 4 is a schematic view of the structure in a second embodiment; and

FIG. 5 is a flowchart of another embodiment method.

### DETAILED DESCRIPTION OF THE INVENTION

The invention uses the interference of two laser beams to define the stripe photoresist pattern of a micro grating for a tunable grating. This method can reduce the period of the grating. By adjusting the interference angle of the two laser beams, the period of the micro grating can be tacitly tuned to reflect light of different wavelengths.

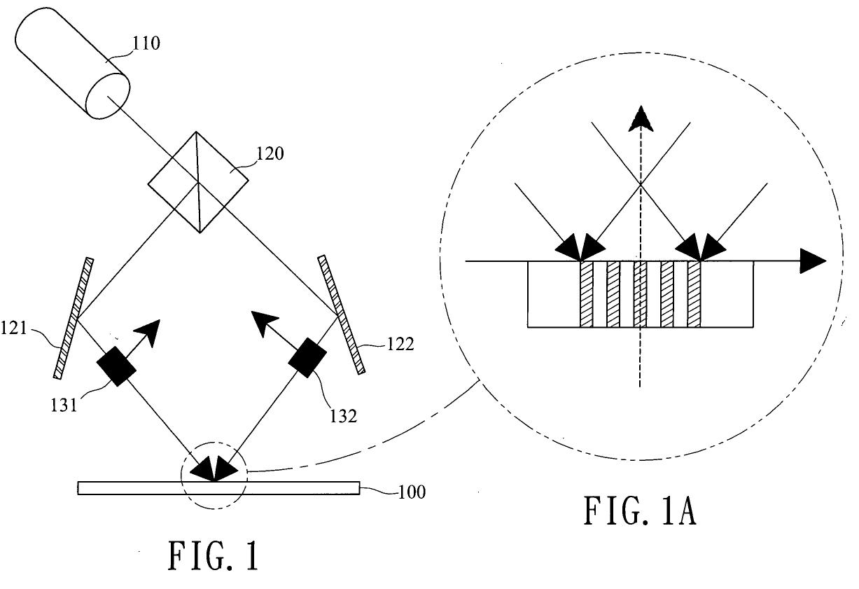

The laser interference device used in the invention is shown in FIG. 1. It mainly contains a laser source 110, a beam splitter 120, reflective mirrors 121, 122, light-emitting modules 131, 132, and a substrate 100. The optical beam sent out from the laser source 110 is split into two beams by the beam splitter 120. The two beams are reflected by two reflective mirrors 121, 122 to two light-emitting modules 131, 132 of the same power and symmetric in space. The light-emitting modules 131, 132 contain a spatial filter and a lens.

The light-emitting module 131, 132 produce radiating, parallel, and convergent light. Through the optical paths of the same lengths, they are cast onto the substrate, generating an interference pattern. After appropriate exposure, the photoresist layer obtains a periodic exposure structure as shown in FIG. 1A.

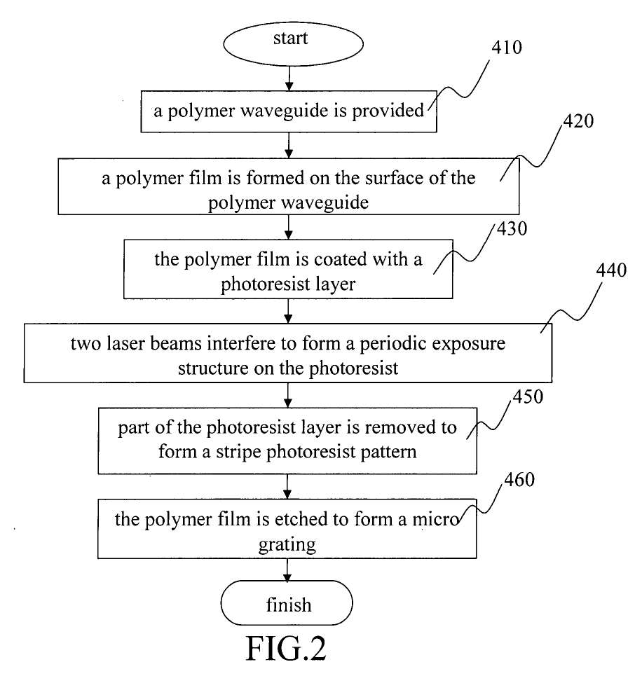

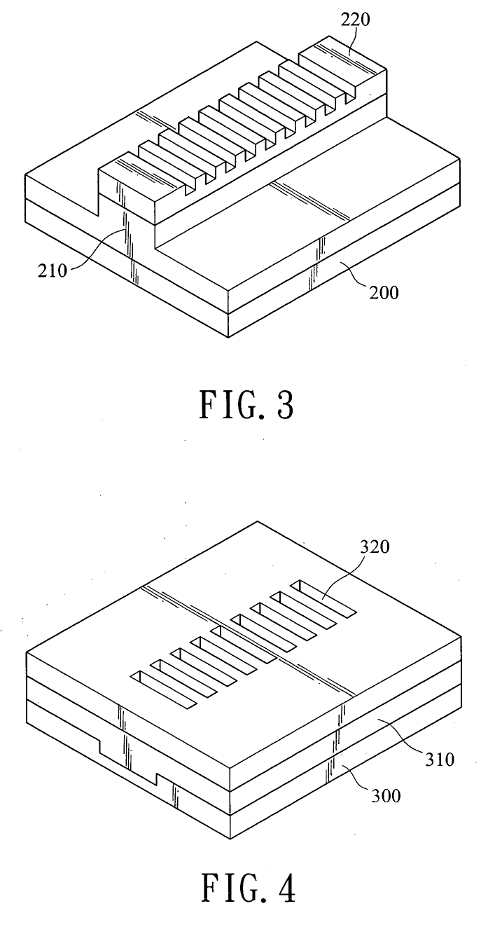

Please refer to FIG. 2 for integrating the above-mentioned micro grating manufacturing process into a tunable filter. The drawing shows the flowchart of a first embodiment of the invention. First, a polymer waveguide is provided (step 410). A polymer film is formed on the surface of the polymer waveguide (step 420). The polymer film is coated with a photoresist layer (step 430). The substrate is then placed in the above-mentioned laser interference device. Two laser beams interfere to form a periodic exposure structure on the photoresist (step 440). Part of the photoresist layer is removed to form a stripe photoresist pattern (step 450). Finally, the polymer film is etched to form a micro grating (step 460), followed by removing the stripe photoresist pattern. The structure thus formed is shown in FIG. 3. The structure of the tunable filter includes a glass substrate 200, a ridge polymer waveguide 210, and a micro grating 220 thereon. The period of the micro grating 220 is about 500 nm.

Another structure in a second embodiment of the invention is shown in FIG. 4. Grooves are first formed on the glass substrate 300 by etching. A polymer layer is coated in the grooves to form a rib polymer waveguide 310. Afterwards, a polymer film and a photoresist layer on its surface are coated. Employing the above-mentioned laser beam interference method, a stripe photoresist pattern is formed. The polymer film is etched to form a micro grating 320 on the surface of the polymer waveguide.

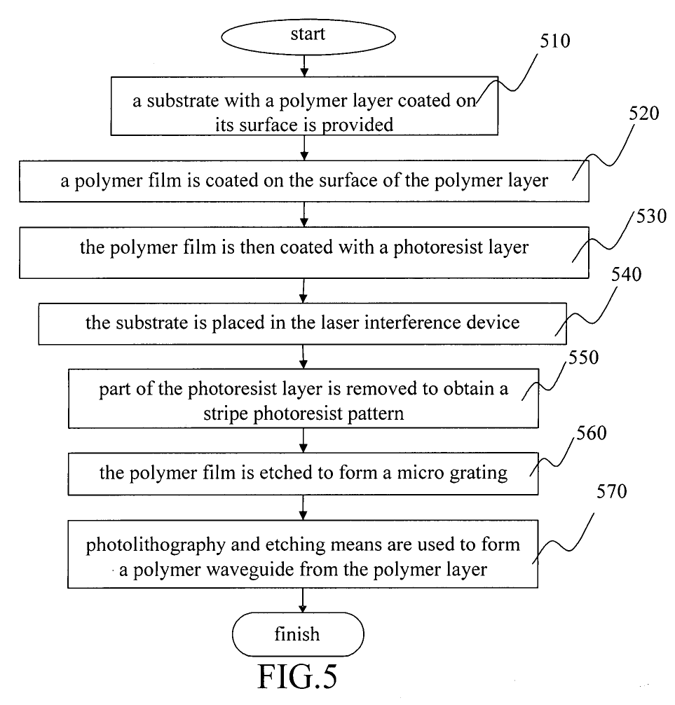

Moreover, one can first use the two laser beam interference means to finish the micro grating before making the waveguide structure. FIG. 5 shows the manufacturing flowchart of another embodiment. First, a substrate with a polymer layer coated on its surface is provided (step 510). A polymer film is coated on the surface of the polymer layer (step 520). The polymer film is then coated with a photoresist layer (step 530). The substrate is placed in the laser interference device (step 540). Part of the photoresist layer is removed to obtain a stripe photoresist pattern (step 550). The polymer film is etched to form a micro grating (step 560), followed by removing the stripe photoresist pattern. Finally, photolithography and etching means are used to form a polymer waveguide from the polymer layer (step 570).

The disclosed polymer waveguide can be accomplished using photolithography and etching. The step of etching the polymer film to form the micro grating can use the inductive coupled plasma (ICP) etching. In particular, the depth of the grooves on the micro grating is etched to greater than 100 nm. This can effectively shorten the length of the tunable filter to smaller than 1 cm. This is perfect for current optical communication devices.

When light is guided into the micro grating from one side, it satisfies the Bragg wavelength as it propagates inside the micro grating: _{B}=2n_{eff}Λ, where λ_{B} is the Bragg wavelength, n_{eff} is the effective refractive index, and Λ is the grating period. In this case, the light is reflected by the micro grating to different paths for output, thereby achieving the goal of filtering. Utilizing the high thermo-optical coefficient of the polymer materials, one can control the device temperature to tune its filtering function.

Certain variations would be apparent to those skilled in the art, which variations are considered within the spirit and scope of the claimed invention.

1. A tunable filter comprising:
a polymer waveguide, which provides a wave guiding structure for optical transmissions; and
a micro grating, which is installed on the surface of the polymer waveguide to reflect an optical signal of a wavelength transmitted in the waveguide structure to another path;
wherein the micro grating is formed by first defining a stripe photoresist pattern on the surface of a polymer film using the interference of two laser beams and then etching the polymer film, the refractive index of the polymer film varies with temperature, the wavelength of the reflected optical signal is determined by tuning the micro grating.

2. The tunable filter of claim 1, wherein the period of the micro grating is between 400 nm and 600 nm.

3. The tunable filter of claim 1, wherein the polymer waveguide is a ridge polymer waveguide.

4. The tunable filter of claim 1, wherein the polymer waveguide is a rib polymer waveguide.

5. A method for making a tunable filter by preparing a polymer waveguide and a micro grating on the polymer waveguide, the method comprising the steps of:
providing a polymer waveguide;
forming a polymer film on the surface of the polymer waveguide;
coating a photoresist layer on the surface of the polymer film;
forming a periodic exposure structure on the photoresist layer using the interference of two laser beams;
removing part of the photoresist layer to form a stripe photoresist pattern; and
etching the polymer film to form the micro grating.

6. The method of claim 5, wherein the polymer waveguide is a ridge polymer waveguide.

7. The method of claim 5, wherein the polymer waveguide is a rib polymer waveguide.

8. The method of claim 5, wherein the step of etching the polymer film to form the micro grating employs the inductively coupled plasma (ICP) etching means to etch the polymer film.

9. The method of claim 5, wherein the period of the micro grating is between 400 nm and 600 nm.

10. A method for making a tunable filter by preparing a polymer waveguide and a micro grating on the polymer waveguide, the method comprising the steps of:
providing a polymer waveguide, whose surface contains a polymer layer;
forming a polymer film on the surface of the polymer waveguide;
coating a photoresist layer on the surface of the polymer film;
forming a periodic exposure structure on the photoresist layer using the interference of two laser beams;
removing part of the photoresist layer to form a stripe photoresist pattern;
etching the polymer film to form the micro grating; and
using photolithography and etching means to form the polymer waveguide on the polymer layer.

11. The method of claim 10, wherein the step of etching the polymer film to form the micro grating employs the inductively coupled plasma (ICP) etching means to etch the polymer film.

12. The method of claim 10, wherein the period of the micro grating is between 400 nm and 600 nm.
